(19) United States
(12) Patent Application Publication
(10) Pub. No.: US 2013/0052319 A1
(43) Pub. Date: Feb. 28, 2013

(54) Whipped cream product and method for making the same

(71) Applicants: Neal B. Julien, Sun Lakes, AZ (US); Woodrow C. Monte, Depoe, OR (US)

(72) Inventors: Neal B. Julien, Sun Lakes, AZ (US); Woodrow C. Monte, Depoe, OR (US)

(21) Appl. No.: 13/507,074

(22) Filed: Jun. 1, 2012

Related U.S. Application Data
(60) Provisional application No. 61/519,974, filed on Jun. 2, 2011.

(51) Int. Cl. A23G 3/52

(52) U.S. Cl. 426/329

(57) ABSTRACT

A process to produce a food product comprises the steps of heating raw cream; admixing at least one bubble stabilizer, at least one acidifier, at least one surface tension modifier, and sucrose in said raw cream to produce a stabilized cream mixture; whipping the stabilized cream mixture to introduce air into the mixture; and, adding inclusions to the whipped, stabilized cream mixture.

This application claims priority based on provisional patent application Ser. No. 61/519,974 filed Jun. 2, 2011.

This invention relates to food products and methods of making the same.

More particularly, the invention relates to a whipped cream food product.

We have discovered a new whipped cream food product and method of producing the same. In one embodiment of the whipped cream product of the invention, ice cream inclusions are incorporated in a non-dairy whipped cream product called “PASTRY PRIDE”. PASTRY PRIDE is similar to COOL WHIP. A mixer whips PASTRY PRIDE while flavoring, ribbons, nuts, etc. are added.

In another embodiment of the whipped cream food product of the invention 40% butterfat heavy manufacturing “real” whip cream (or any other desired milk based whipped cream) is stabilized so that the cream will not separate and so that the cream will hold inclusions or flavor “ribbons” for at least a two week refrigerated shelf life.

In a further embodiment of the whipped cream food product of the invention, inclusions are incorporated in COOL WHIP and the COOL WHIP is frozen to provide an extended shelf life.

Cream is the yellowish part of milk containing from eighteen to about forty percent butterfat. Cream can be whipped until stiff—forming whipping cream. As noted, in one preferred embodiment of the invention cream (from milk) is stabilized so that whipping cream produced from the cream will hold inclusions for at least a two week refrigerated shelf life. Possible stabilizers include cellulose gum, agar-agar, carrageenan, gellan gum, guar gum, konjac, hydroxypropyl cellulose, methylcellulose and hydroxypropyl cellulose, xanthan gum, gum Arabic, starch, pectin, gelatin, propylene glycol alginate, or a combination. The stabilizer may have a gel form, such as cellulose gel. Bulking agents can be utilized in the cream formulation, such a corn syrup, corn syrup solids, maltodextrin, and dextrose.

The whipped cream—inclusion product of the invention can be provided in coffee shops or other retail outlets via a counter top unit; or, can be provided in grocery stores in various package sizes as a premade product.

Some examples of inclusions which can be utilized in the whipped cream product of the invention are chocolate chips, chocolate mint chips, rocky road chips, butter pecan chips, vanilla flavored chips, carmel swirl (carmel syrup wrapped into whipped cream), walnuts, sugar coated pecans, almond chips, whole almonds, and marshmallows.

In another embodiment of the whipped cream product of the invention rice milk, almond milk, soy milk, and or kefir's cultured milk are utilized.

Typical ingredients of the 40% butterfat heavy manufacturing “real” whip cream are cream (milk), carrageenan, mono and diglycerides and polysorbate 80.

In another embodiment of the invention a whipped cream mixture comprises one half PASTRY PRIDE (for stability) and one half ALTA DINA heavy manufacturing cream (40%) to produce a whipping cream base mix. Praline chips are added when the mixture is whipped. A one pint cream canister with a nitrous oxide whipped cream charger is utilized to achieve the desired 200% overrun. The proportion of PASTRY PRIDE and ALTA DINA can be adjusted as desired.

In a further embodiment of the invention, ALTA DINA heavy manufacturing cream (ingredients comprising cream (milk), carrageenan, mono and diglycerides, and polysorbate 80) comprises 100% of the base mixture. It whips up to about 100% overrun and within four refrigerated days it begins bleeding air and liquid moisture.

In another embodiment of the invention, aseptic dairy products are utilized. An advantage of preparing the whipping cream of the invention in aseptic containers is the ease of keeping the product at room temperature before it is put into the “whipping machine”. Utilizing a refrigerated product may be less expensive than aseptic packaging.

In a further embodiment of the invention a lactose free dairy product is utilized. The whipping cream product and system of the invention provides a new method for, via whipped cream, storing and dispensing for ingestion inclusions, flavorings, etc. The whipping cream product and system of the invention provides a new method for, via whipped cream, incorporating inclusions, flavorings, etc. in ice cream and other food compositions.

The whipping cream product and system of the invention provides a new method for storing inclusions and flavorings in a suspension for later use.

### EXAMPLE 1

The following ingredients are provided to produce a dairy cream mixture in accordance with one embodiment of the invention.

TABLE I
Industrial Formulation for Final Cream Mixture
in Pounds and Ounces

| | | | | | Grams to |
|---|---|---|---|---|---|
| | | | | | add to a |
| | | | | | Ballon |
| | | | | | 40% BF |
| Ingredient | LBS | OZS | GRAMS | % | Cream |
| 1000 GAL 40% | 8370 | | 3796548 | 90.049 | 3796.5 |
| BF Cream (heat | | | | | |
| cream to 165 | | | | | |
| degrees F. for | | | | | |
| one hour | | | | | |
| BUCKET 1 | | | | | |
| MYVEROL | 2 | 3.3 | 1000 | 0.024 | 1.0 |
| (18085) | | | | | |
| DARFAX EOM | 1 | 12.2 | 800 | 0.019 | 0.8 |
| TWEEN 80 | 1 | 1.6 | 500 | 0.012 | 0.5 |
| TWEEN 60 | 4 | 6.5 | 2000 | 0.047 | 2.0 |
| SPAN 60 | 7 | 15.0 | 3600 | 0.085 | 3.6 |
| BUCKET 2 | | | | | |
| AVICEL RC581 | 17 | 10.2 | 8000 | 0.190 | 8.0 |
| METHOCEL 4 | 3 | 8.4 | 1600 | 0.038 | 1.6 |
| KM | | | | | |
| GUAR GUM | 1 | 12.2 | 800 | 0.019 | 0.8 |
| XANTHAN GUM | 2 | 0.5 | 920 | 0.022 | 0.9 |
| BUCKET 3 | | | | | |
| CITRIC ACID | | 10.6 | 300 | 0.007 | 0.3 |
| BUCKET 4 | | | | | |
| SUCROSE | 881 | 13.7 | 400000 | 9.488 | 400.0 |
| TOTALS | 9383 | | 4216068 | 100.000 | |

The citric acid functions to adjust the pH slightly so the ingredient work together more effectively. The citric acid reacts, against some of the buffering effects of casein proteins. The quantity of citric acid utilized preferably is in the range of 80 to 1000 grams. Other acidifiers (formic acid, acetic acid, or malic acid) can be utilized in place of or in combination with citric acid, but citric acid is a common dairy ingredient so a dairy would not have to buy anything new.

In BUCKET 2 above, Avicel and Methocel are cellulose gums. These gums, along with the guar gum and xanthan gum, are believed to function to introduce stability in the foam that is created when the resulting cream mixture is whipped to introduce air and produce “over run”.

Methocel includes methanol added to it in an inseparable way. Although the invention can be practiced utilizing a cellulose gum in combination with only xanthan gum, or utilizing only a cellulose gum, or possibly utilized other gum combinations, In the current practice of the invention it is preferred to include a cellulose gum, xanthan gum, and guar gum.

The quantity of Avicel is in the range of 2000 to 16000 grams, of Methocel is in the range of 800 to 3200 grams, of guar gum is in the range of 400 to 1600 grams, and of xanthan gum is in the range of 100 to 1000 grams.

In BUCKET 1, Myverol and Darfax each include mono and diglycerides. They are believed to function as stabilizers and help in the formation of bubbles when the final cream mixture of the invention is whipped to introduce air. Tween 60 and Tween 80 and Span 60 are believed to function to alter the surface tension of liquid and loosen it so foam bubbles can form. Myverol and Darface are believed to break fat down into smaller particles to the fat can fit in small layers formed around foam bubbles.

Any desired mono and diglyceride composition can be utilized in the practice of the invention, as well as any equivalent(s) for Tween 60, Tween 80 and/or Span 60.

The quantity of Tween 80 is preferably in the range of 100 to 500 grams, of Tween 60 is preferably in the range of 1000 to 2000 grams, of Span 60 is preferably in the range of 800 to 3600 grams, of Myverol is preferably in the range of 500 to 1500 grams, and of Darfax is preferably in the range of 200 to 1000 grams.

In BUCKET 4, the quantity of sucrose can be varied as desired.

### EXAMPLE 2

TABLE II
Formulation to Produce Four Liters of Final Cream Mixture

| | | Grams to add to a Four |
|---|---|---|
| Ingredient | Liters | Liters of 40% BF Cream |
| 1000 GAL 40% | 4.0 (About one | |
| BF Cream (heat cream | gallon) (3,926 | |
| to 165 degrees F. for | grams) | |
| one hour | | |
| BUCKET 1 | | |
| MYVEROL (18085) | | 1.0 |
| DARFAX EOM | | 0.8 |
| TWEEN 80 | | 0.5 |
| TWEEN 60 | | 2.0 |
| SPAN 60 | | 3.6 |
| BUCKET 2 | | |
| AVICEL RC581 | | 8.0 |
| METHOCEL 4 KM | | 1.6 |
| GUAR GUM | | 0.8 |
| XANTHAN GUM | | 0.9 |
| BUCKET 3 | | |
| CITRIC ACID | | 0.3 |
| BUCKET 4 | | |
| SUCROSE | | 400.0 |
| BUCKET 5 | | |
| VANILLA EXTRACT | | 7.5 |
| TOTALS | | |

### EXAMPLE 3

Mix preparation using the ingredients of EXAMPLE 2.
1. Provide tall stainless steel pan or kettle.
2. Use electric stirring paddles in kettle.
3. Pour the four liters of 40% butterfat cream into the kettle. The cream preferably, but not necessarily, comprises raw cream.
4. Heat the kettle over medium heat on burner.
5. Heat cream to 150 to 155 degrees F. and remove kettle from burner. Continue stirring kettle until temperature reaches no more than 160 degrees F. During preparation of the whipped final mix (noted below) of the invention, the cream is heated to a final temperature in the range of 145 degrees F. to 170 degrees F., preferably 150 to 165 degrees F., more preferably 155 to 160 degrees F.
6. Heat the ingredients in BUCKET 1 for about 20 seconds in a microwave.
7. Remove about one fourth of the cream (about 32 ounces) of the heated cream from the kettle and place in a blender. Turn the blender on low and slowly add the ingredients in BUCKET 1 to the blender to produce a cream/BUCKET 1 mix.
8. Put the cream/BUCKET 1 mix in the kettle and admix with the cream which was left in the kettle to produce a cream/BUCKET 1 mixture in the kettle.
9. Remove about one fourth of the cream/BUCKET 1 mixture from the kettle and place in a blender. Turn the blender on low and slowly add the ingredients in BUCKET 2 to the blender to produce a cream/BUCKET 1/BUCKET 2 MIX.
10. Put the cream/BUCKET 1/BUCKET 2 mix in the kettle and admix with the cream/BUCKET 1 mixture which was left in the kettle to produce a cream/BUCKET 1/BUCKET 2 mixture in the kettle.
11. Add one fluid ounce of water to BUCKET 3 and shake well until the citric acid is dissolved. Slowly mix the resulting citric acid solution to the cream/BUCKET 1/BUCKET 2 mixture in the kettle.
12. Add the ingredient in BUCKET 4 to the kettle and mix to produce a cream/BUCKET 1/BUCKET 2/citric acid/sucrose mixture.
13. Homogenize at 500 psi on a single stage the cream/BUCKET 1/BUCKET 2/citric acid/sucrose mixture.
14. Admix the ingredient in BUCKET 5 to the homogenized mixture to produce a final mix.
15. Place final mix in container(s) and chill in ice water to cool the final mix as quickly as possible. After cooling the mix to about thirty-five degrees F., store the mix in a refrigerator for at last twelve hours prior to whipping the mix and then adding desired inclusions/flavoring. When the final mix is whipped, an “over run” in the range of 150% to 250% is produced, i.e., the whipped mix includes one and one-half to two and one-half parts of air (by volume) for each part (by volume) of the final mix.

The amount of butterfat in the dairy cream utilized in the dairy embodiment of the invention is in the range of 2% to 41.5% by volume, preferably in the range of 20% to 40% by volume. It is preferred, although not necessary, to utilize raw cream in the process described above. One reason dairy cream is preferred in the practice of the invention is that it can be refrozen.

When inclusions are admixed to whipped final mix, the inclusions comprise from 1% to 30% by volume, preferably 5% to 28%, more preferably 10% to 25% by volume of the resulting whipped final mix/inclusion mixture.

One embodiment of the invention comprises a system to store inclusions (nuts, chocolate drops, sugar sprinkles, fruit pieces, etc.) for later use which system comprises storing the inclusions in the whipped final mix which is produced in accordance with the invention.

Another embodiment of the invention comprises a process to create a new food product by producing a whipped final mix and then admixing inclusions, flavorings, or other desired components in the whipped final mix.

A further embodiment of the invention comprises a process for producing a novel food product by combining or mixing a whipped final mix/inclusion/flavoring product (produced in accordance with one embodiment of the invention) with coffee/tea or another beverage or food product.

Having described our invention is such terms as to enable those of skill in the art to understand and practice it, and having described the presently preferred embodiments thereof, We claim:

1. A process to produce a food product, comprising the steps of
(a) heating raw cream;
(b) admixing at least one bubble stabilizer, at least one acidifier, at least one surface tension modifier, and sucrose in said raw cream to produce a stabilized cream mixture;
(c) whipping said stabilized cream mixture to introduce air into said mixture; and,
(d) adding inclusions to said whipped, stabilized cream mixture.
